(19) United States
(12) Patent Application Publication
(10) Pub. No.: US 2025/0291437 A1
(43) Pub. Date: Sep. 18, 2025

(54) ELECTRONIC DEVICE AND METHOD FOR PLAYING A REACTIVE VIDEO BASED ON INTENTION AND EMOTION OF INPUT MANIPULATION TO THE REACTIVE VIDEO

(71) Applicant: Chul Woo LEE, Seoul (KR)

(72) Inventor: Chul Woo LEE, Seoul (KR)

(21) Appl. No.: 19/172,150

(22) Filed: Apr. 7, 2025

Related U.S. Application Data
(63) Continuation of application No. PCT/KR2023/015415, filed on Oct. 6, 2023.

(30) Foreign Application Priority Data
Oct. 7, 2022 (KR) 10-2022-0128759
Oct. 5, 2023 (KR) 10-2023-0132326

(51) Int. Cl. G06F 3/041; G06F 3/01

(52) U.S. Cl. CPC G06F 3/04146; G06F 3/011; G06F 3/0412

(57) ABSTRACT

The present disclosure relates to an electronic device for playing back a reactive video based on an intention and an emotion of an input manipulation on the reactive video and a method thereof. An electronic device according to the present disclosures may include a touchscreen that displays a reactive video; and a processor that controls a playback operation of the reactive video, and the processor may receive an input manipulation on one screen of the reactive video through the touchscreen, may identify at least one of an intention and an emotion of the input manipulation based on at least one of a characteristic, a speed, and a pressure of the input manipulation, may identify a playback type of the reactive video based on at least one of the intention and the emotion of the input manipulation, and may play back the reactive video based on the identified playback type.

### CROSS-REFERENCE TO RELATED APPLICATIONS

The present application is a Continuation of International Application No. PCT/KR2023/015415 filed on Oct. 6, 2023, which is based upon and claims the benefit of priority to Korean Patent Application No. 10-2022-0128759 filed on Oct. 7, 2022, and Korean Patent Application No. 10-2023-0132326 filed on Oct. 5, 2023, the entire contents of which are incorporated herein by reference.

### TECHNICAL FIELD

The present disclosure relates to an electronic device playing a reactive video and a method thereof. More particularly, the present disclosure relates to an electronic device playing a reactive video based on an intention and an emotion of an input manipulation to the reactive video.

### BACKGROUND ART

Nowadays, an imaging technology is being very advanced. A mobile terminal such as a smartphone, in addition to a camcorder and a digital camera, may capture a high-resolution video. In addition, a 360-degree camera, a 3D video camera, etc. are appearing.

After the video is recorded by a video recording device, the video is stored in a specific format and is played back by a playback terminal. The video is played back in chronological order non-interactively, that is, without interaction with a viewer. That is, the viewer may only feel the visual sense through the played video.

### DETAILED DESCRIPTION OF THE INVENTION

### Technical Problem

The present disclosure is directed to provide an electronic device for playing back a reactive video by identifying an intention and/or an emotion of a user's input manipulation on the reactive video and performing various condition playbacks based on a result of the identification.

The problems to be solved by the present disclosure are not limited to the problems mentioned above, and any other problems not mentioned will be clearly understood by one skilled in the art from the following description.

### Technical Solution

According to an embodiment for achieving the above problems, an electronic device may include a touchscreen that displays a reactive video, and a processor that controls a playback operation of the reactive video. The processor may receive an input manipulation on one screen of the reactive video through the touchscreen, may identify at least one of an intention and an emotion of the input manipulation based on at least one of a characteristic, a speed, and a pressure of the input manipulation, may identify a playback type of the reactive video based on at least one of the intention and the emotion of the input manipulation, and may play back the reactive video based on the identified playback type.

In addition, according to an embodiment for achieving the above problems, a method which plays back a reactive video based on an intension and an emotion of an input manipulation on the reactive video and is performed by an electronic device, may include displaying the reactive video on a touchscreen of the electronic device, when the input manipulation on one screen of the reactive video is received, identifying at least one of the intention and the emotion of the input manipulation based on at least one of a characteristic, a speed, and a pressure of the input manipulation, identifying a playback type of the reactive video based on at least one of the intention and the emotion of the input manipulation, and playing back the reactive video based on the identified playback type.

In addition, a computer-readable recording medium storing a computer program for executing a method for implementing the present disclosure may be further provided.

### Advantageous Effects of the Invention

According to the above technical solution of the present disclosure, user experience may be improved in terms of interactivity, by playing back a reactive video based on an intention and an emotion of an input manipulation.

The effects of the present disclosure are not limited to the effects mentioned above, and any other effects not mentioned will be clearly understood by one skilled in the art from the detailed description.

### DESCRIPTION OF THE DRAWINGS

FIG. 1 is a block diagram illustrating a configuration of an electronic device for identifying an intention or an emotion of a user input, according to the present disclosure.

FIG. 2 is a flowchart for describing an operation of an electronic device playing back a reactive video based on an intention or an emotion of an input manipulation, according to the present disclosure.

FIG. 3 illustrates one screen of a reactive video, according to the present disclosure.

FIG. 4A illustrates a method of measuring a speed of an input manipulation, according to the present disclosure.

FIG. 4B illustrates a method of indicating an emotion of an input manipulation, according to the present disclosure.

FIGS. 5A and 5B illustrates a method of measuring a pressure of an input manipulation, according to the present disclosure.

### BEST MODE

The same or similar reference numerals/signs refer to the same or similar components throughout the present disclosure. The present disclosure does not describe all components of embodiments, and the general content in the technical field to which the present invention pertains or the duplicated content between the embodiments is omitted. The terms “unit”, “module”, “member”, and “block” used in the specification may be implemented by using software or hardware. Depending on embodiments, a plurality of “units”, “modules”, “members”, and “blocks” may be implemented with a single component, or a single “unit”, “module”, “member”, and “block” may include a plurality of components.

Also, when it is mentioned that a part “includes” a certain component, this means that any other component(s) may be further included, rather than excluding any other component(s), unless otherwise stated.

A singular expression includes a plural expression, unless there are obvious exceptions in the context. In each step, a reference sign is used for convenience of description, and the reference sign does not describe the order of respective steps. Each step may be carried out to be different from the specified order unless the specific order is clearly stated in the context.

Prior to describing an operation principle and embodiments of the present disclosure with reference to the accompanying drawings, some terms will be described as follows.

Contents or content may include various kinds of content, which are visually provided, such as a video, a still image, and a hologram and may also include a variety of content which are provided in an audible manner, a tasteful manner, an olfactory manner, etc., but an embodiment is not limited thereto. In addition, the content may be provided in virtual reality (VR), but an embodiment is not limited thereto.

An object included in the content may be included in a part of the content or may include the entire content. For example, when the content is a video, the content may include various objects present in all or some of the frames of the video and may mean the video itself.

When a “command (an input manipulation) triggering a reaction, a feedback, etc.” of the object included in the content (e.g., a reserved command including a touch manipulation, a sound command, a motion command, etc.) is input, reactive content may include a variety of content associated with the object corresponding thereto. Below, the description will be given under the assumption that the reactive content according to the present disclosure is a reactive video, and a type of the reactive content according to the present disclosure is not limited to a video.

Herein, the reaction may include the following according to the command (input manipulation): a movement of the object, a change in a shape of the object, occurrence of a specific event, and/or a change in content, but an embodiment is not limited thereto.

The reactive video refers means a video which is played back in a form corresponding to the command (e.g., a touch manipulation) by the user (i.e., a viewer) viewing the video. For example, the reactive video may mean a video in which the movement of touching the object is played back when a user manipulation is applied to a touchscreen by the user in the form of touching a specific object (e.g., a pillow). Also, for example, the reactive video may mean a video in which, when a user manipulation is applied to a touchscreen in the form of pressing a specific object, the movement that the object is pressed and the movement that the restoration is made after the user manipulation are played back.

The “command (input manipulation) for triggering a reaction” of the object included in the content may include a user manipulation to the content, which is received through an input means of a computer providing the reactive video. For example, the user manipulation may include a manipulation capable of being input to a specific point or region in the content through an input means such as a mouse or a touchscreen (e.g., a click manipulation, a drag manipulation, a contact touch manipulation of a specific time or more, or a force touch manipulation (i.e., a touch manipulation which applies a specific pressure to a touchscreen or a touch pad)). In addition, for example, the user manipulation may include an arrangement state or a movement of a terminal itself, which is capable of being obtained by using a sensor (e.g., an acceleration sensor or a gyro sensor) included in the computer (or terminal) as an input means. When the content is VR content, the command for triggering the reaction may be executed by motion sensing of a worn terminal or a manipulation of a terminal such as a joystick, but an embodiment is not limited thereto.

Below, a method of generating a reactive video will be described. The description will be given under the assumption that the generation of the reactive video is performed by a processor of a device (e.g., a computer).

A processor 1410 may determine a command for triggering a reaction of an object included in one or more original videos. Herein, the original video may be referred to as a “basic video”, and the original video may be content which is not implemented reactively. For example, the original video may be recording content and may include a plurality of frame combinations storing a frame for each location of an object in a space. The original video may be content collected through communication, and may be three-dimensional or VR content. However, an embodiment is not limited thereto.

The processor 1410 may receive an input specifying a frame period of the original video, and the frame interval may include a specific interval including frames, which will be implemented reactively, from among all the frames of the original video. The frame interval may be set from the user through various manners. In an embodiment, the processor 1410 may receive selection from a start frame (i.e., a first frame of a time domain to be created to the reactive video) to a final frame (i.e., a last frame of a time domain to be created to the reactive video) of the original video from the user. Also, in an embodiment, a time interval may be designated by the user.

The processor 1410 may connect to the reactive video and may directly receive the command for triggering the reaction of the object from the user. For example, in the case of a device including a touchscreen, the processor 1410 may provide the process of receiving a specific input manipulation from the user and may receive a specific command depending on an object moving on the touchscreen in the corresponding process.

In addition, the processor 1410 may receive a command type for connection with the reactive video, which is selected by the user, and may receive a manipulation capable of replacing the corresponding command type. For example, in the case where there is used a computer (also including a VR device) being a device not including a touchscreen while generating a reactive video in a device including a touchscreen, the computer may receive a mouse manipulation instead of a touch manipulation on the touchscreen, that is, may generate the reactive video.

The command for triggering the reaction of the object may coincide with movement of an object included in the frame interval or may correspond to the movement of the object. The location or region which is set such that the command for triggering the reaction of the object is input may correspond to a region corresponding to movement of an object in a frame included in the frame interval.

To connect the object with the command for triggering the reaction of the object, the processor 1410 may apply a manner of generating a virtual layer to the entire region of each of frames in a specified frame interval of the original video or a specific region of each of the frames. The virtual layer may mean a layer which is capable of receiving an input of the user while being not virtually expressed on a screen and is overlaid on a frame constituting the original video.

When the command for triggering the reaction of the object is a manipulation which moves a specific region on a frame (i.e., a path through which the object in the frame interval moves) (e.g., movement of a mouse cursor through a mouse manipulation or a drag manipulation from a first point to a second point on the touchscreen), the processor 1410 may generate the virtual layer, which is composed of a specific number of detailed cells, on the frame.

Also, the processor 1410 may generate a virtual layer composed of a plurality of detailed cells so as to correspond to the frame interval. The processor 1410 may calculate the number of frames to be included in the frame interval, may apply the number of frames in the frame interval to the number of detailed cells, and may sequentially match each frame in the frame interval to each detailed cell.

For example, in the case of intending to generate content such that “n” frames are played back variably (i.e., manipulation-played back) depending on the command for triggering the reaction of the object, the processor 1410 may divide the specific region into “n” detailed cells.

Afterwards, the processor 1410 may match each frame to each of the divided detailed cells such that the matched frame is provided when a specific detailed cell is selected or specified. That is, when an object (e.g., a hand) moves in a specific direction and a virtual layer is generated along a moving path of the object, the processor 1410 may match each detailed cell to each frame in the frame interval in order from a detailed cell of a first point at which the object starts to move.

Also, the processor 1410 may generate the plurality of detailed cells constituting the virtual layer to have different sizes or at different intervals. Assuming that a speed at which the object moves in the frame interval of the original video changes, when the virtual layer is divided into detailed cells with the same size, a location of the object on the frame may not be matched to a location of the detailed cell. Accordingly, the processor 1410 may make the detailed cells different in size or interval, so as to coincide with the movement of the object. That is, because it is possible to obtain a frame of an object moving while a speed changes at the same time interval when video content is played back, an interval between object locations in continuous frames is wide in an interval in which the object moves quickly, and an interval between object locations in continuous frames is narrow in an interval in which the object moves slowly. Accordingly, the processor 1410 should generate a plurality of detailed cells to coincide with an object interval in the frame such that a location of an input manipulation (the command for triggering the reaction of the object) which the user inputs is matched to an object location in the frame.

Also, the processor 1410 may determine the length of the virtual layer. In an embodiment, the processor 1410 may recognize a path through which the object moves by identifying a location of each object (or a specific feature point of each object) in the frame interval and may form the virtual layer with a length including the corresponding path. Also, the processor 1410 may determine shapes of the virtual layer and the detailed cell.

The reactive video may be content which is recorded and is stored in advance or may be content obtained by adding additional content to the original video or composing the additional content and the original video. For example, the reactive video may include a moving image, a still image, a hologram, etc., and when the original video is played back, the additional content may be played back together to make the original video into the reactive video.

Also, the reactive video may include a multi-reactive video, and the multi-reactive video may mean content which changes or is played back in the form corresponding to a specific input manipulation of the user (i.e., the viewer) viewing the content. For example, the multi-reactive video may mean a video which is played back as if an object in the video moves depending on a manipulation of the user as a corresponding input manipulation of the user connects to specific movement of the original video.

In an embodiment, a compression video means a video which is compressed in units of minimum movement to implement the basic video as the reactive video. For example, when the same movement is repeatedly included in the basic video, the compression video is only one movement remaining after deleting the repeated movements. Furthermore, for example, when the basic video includes both a movement from a first location to a second location and a movement from the second location to the first location, the compression video may include only the basic video moving from the first location to the second location, and the movement from the second location to the first location may be implemented by playing back the remaining basic video in reverse.

Also, a multi-reactive video generation file which is generated by compressing a plurality of basic videos is a content file capable of playing back a plurality of operations depending on a manipulation of the user or metadata capable of being implemented as a multi-reactive video as the multi-reactive video generation file is played together with one or more basic videos. In an embodiment, even though duplication is allowed, the processor 1410 may generate the reactive video without generating the compression video.

In an embodiment, the processor 1410 may generate or output the reactive video from the basic video (the basic video may be the reactive video) without using the compression video and by using all the repeated movements without deletion.

Below, a multi-reactive video generating method according to the present disclosure will be described, and it will be assumed that content is a video.

The processor 1410 may obtain a basic video. The basic video may be an original video including a movement of an object to be implemented reactively depending on a manipulation of the user. A reactive video creator (e.g., a content provider or an individual user) may record a video including an operation to be implemented reactively.

In an embodiment, the processor 1410 may obtain a video for a plurality of movements of the same object from the user and may then generate a multi-reactive video. For example, when an object is a user's hand, a control module (1500) (190) may obtain a plurality of videos of moving or bending in a plurality of directions in a state where a user's index finger is unfolded.

Also, when the user intends to create a reactive video in which the user's head is rotated vertically or horizontally or the user's facial expression is changed as a reaction according to a specific manipulation, the user may record a video including all of the desired head movement and facial expressions.

In addition, when the user intends to generate a reactive video in which a water balloon bursts or pops up from a floor depending on a manipulation input by the user, the user may sequentially record a first video in which water balloons with the same color and size are dropped and then bursts, and a second video in which the water balloons bounce without bursting.

Moreover, the processor 1410 may obtain one basic video in which after a specific movement is made, the existing movement is not repeated, but different events occur. That is, the processor 1410 may obtain a video, in which a plurality of events occur in association with the object, as the basic video.

The processor 1410 may generate the compression video based on the basic video. The compression video may include only the movement of the object to be implemented reactively depending on a manipulation of the user. In an embodiment, a video allowing duplication may be applied instead of the compression video.

The processor 1410 may receive a multi-reactive video generation condition for the compression video. The multi-reactive video generation condition may be a plurality of manipulation inputs corresponding to a reaction capable of being generated from the compression video.

The processor 1410 may generate a stack structure of the compression video, and each extraction region (e.g., a first extraction region and a second extraction region) may include a plurality of stacks associated with different events. For example, a first stack expressed by a solid line and a second stack expressed by a dotted line may be included in each extraction region. The processor 1410 may be implemented to determine a stack, which is to be executed, from among the first stack and the second stack based on a location of each extraction region, at which a first manipulation is received from the user.

Also, a first event and a second event in each extraction region may include pixels overlapping each other. The processor 1410 may maintain only one of pixels overlapping each other in a stack for the first event and a stack for the second event. Even though the compression video includes only data for the overlapping pixels in a specific extraction region, one of the stacks of the first event and the second event may be determined depending on a next manipulation of the user (e.g., a change in a movement direction of a touch manipulation or a change in the intensity of applied pressure). In this way, the computer may generate the compression video with minimal data.

Below, a user interface for generating the reactive video according to an embodiment of the present disclosure will be described. The reactive video may include the multi-reactive video described above and a multidimensional reactive video.

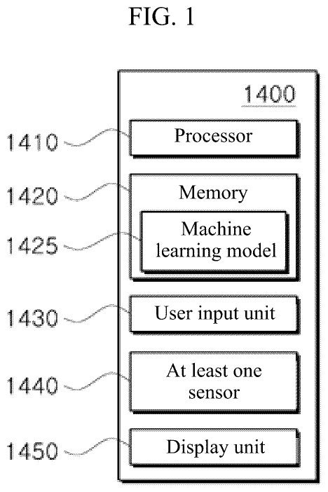

FIG. 1 is a block diagram illustrating a configuration of an electronic device for identifying an intention or an emotion of a user input, according to the present disclosure. In the specification, an electronic device may be understood as an example of a computer.

In an embodiment, an electronic device 1400 may include the processor 1410, a memory 1420, a user input unit 1430, at least one sensor 1440, and a display unit 1450. The components illustrated in FIG. 1 are not essential in implementing the electronic device 1400 according to the present disclosure. The electronic device 1400 described herein may include more or fewer components than those listed above.

In an embodiment, the processor 1410 may be implemented with a memory which stores an algorithm for controlling operations of the components in the device according to the present disclosure or data associated with a program for implementing the algorithm, and at least one processor which performs the above operations by using the data stored in the memory. In this case, the memory and the processor may be respectively implemented with separate chips. Alternatively, the memory and the processor may be implemented with a single chip.

Also, to implement various embodiments of the present disclosure to be described below on the device according to the present disclosure, the processor 1410 may control one of the components described above or a combination of some of the components.

In an embodiment, the memory 1420 may store data for supporting various functions of the device according to the present disclosure and a program for operations of the processor 1410, may store pieces of input/output data (e.g., music files, still images, and videos), and may store a plurality of application programs (or applications) running on the device according to the present disclosure, pieces of data for operations of the device according to the present disclosure, and instructions. At least some of the application programs may be downloaded from an external server through wireless communication.

The memory 1420 may include a storage medium whose type corresponds to at least one type among a flash memory type, a hard disk type, a solid state drive (SSD) type, a silicon disk drive (SDD) type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc, etc. Also, the memory 1420 may be separated from the device according to the present disclosure but may be a database connected by wire or wirelessly.

In an embodiment, the memory 1420 may include a machine learning model 1425. The machine learning model 1425 may use a deep learning manner which is based on a deep neural network. For example, the machine learning model 1425 may be based on a convolution neural network (CNN) manner.

In an embodiment, the user input unit 1430 may be used to receive information from the user. When information is received through the user input unit 1430, the processor 1410 may control operations of the device according to the present disclosure so as to correspond to the received information. The user input unit 1430 may include a hardware-type physical key (e.g., a button, a dome switch, a jog wheel, or a jog switch which is located on at least one of a front surface, a back surface, and a side surface of the device according to the present disclosure) and a software-type touch key. As an example, the touch key may include a virtual key, a soft key, or a visual key displayed on a touchscreen-type display unit through software processing or may include a touch key disposed on a portion other than the touchscreen. Meanwhile, the virtual key or the visual key is capable of being displayed on the touchscreen while having various shapes. For example, the virtual key or the visual key may be implemented by graphics, texts, icons, video, or a combination thereof.

In an embodiment, the at least one sensor 1440 senses at least one of internal information of the device according to the present disclosure, information about an ambient environment surrounding the device according to the present disclosure, and user information and generates a sensing signal corresponding thereto. Based on the sensing signal, the processor 1410 may control the driving or operation of the device according to the present disclosure or may perform data processing, a function, or an operation associated with an application program installed in the device according to the present disclosure.

For example, the at least one sensor 1440 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., a camera), a microphone, an environmental sensor (e.g., including at least one of a barometer, a hygrometer, a thermometer, a radiation detection sensor, a heat detection sensor, and a gas detection sensor), or a chemical sensor (e.g., a healthcare sensor or a biometric sensor). Meanwhile, the device according to the present disclosure may combine and utilize pieces of information sensed by at least two or more sensors among the above sensors.

In an embodiment, the display unit 1450 may have a mutual layer structure with the touch sensor or may be integrated with the touch sensor. Accordingly, the display unit 1450 may implement the touchscreen. The touchscreen may serve as a user input unit which provides an input interface between the user and the device according to the present disclosure and may also provide an output interface between the user and the device according to the present disclosure. That is, the user input unit 1430 and the display unit 1450 may be integrated to implement the touchscreen.

The display unit 1450 displays (outputs) information processed by the device according to the present disclosure. For example, the display unit 1450 may display information of an execution screen of an application program (e.g., an application) running on the device according to the present disclosure or information of a user interface or a graphic user interface according to the execution screen information.

In an embodiment, the display unit 1450 may be used as an input means. For example, the user may perform an input manipulation such as a manipulation (e.g., a click manipulation, a drag manipulation, a contact touch manipulation for a specific time or more, or a force touch manipulation (i.e., a touch manipulation which applies a specific pressure to a touchscreen or a touch pad)), which is capable of being input to a specific point or region in a video, by using the display unit 1450.

In an embodiment, the processor 1410 may display one screen of the reactive video through the display unit 1450. For example, the one screen may be a screen for receiving an input manipulation from the user. The reactive video may include at least one playback type according to the input manipulation.

In an embodiment, the processor 1410 may identify at least one of the intention and the emotion of the input manipulation based on at least one of a characteristic, a speed, and a pressure of the input manipulation. The processor 1410 may identify any one of playback types of the reactive video based on at least one thus identified from among the intention and the emotion of the input manipulation and may display the identified playback type through the display unit 1450. A method of identifying at least one of the intention and the emotion of the input manipulation will be described.

In an embodiment, the processor 1410 may train the machine learning model 1425 by using the characteristic, speed, and pressure information of the input manipulation and at least one of the intention and the emotion of the input manipulation identified thereby. The processor 1410 may input the input manipulation to the machine learning model 1425 completely trained and may obtain information indicating at least one of the intention and the emotion of the input manipulation as an output value.

At least one component may be added or deleted to correspond to the performance of the components illustrated in FIG. 1. Also, it will be easily understood by one skilled in the art that mutual locations of the components are capable of being changed to correspond to the performance or structure of a system.

Meanwhile, each component illustrated in FIG. 1 means software and/or a hardware component such as a field programmable gate array (FPGA) or an application specific integrated circuit (ASIC).

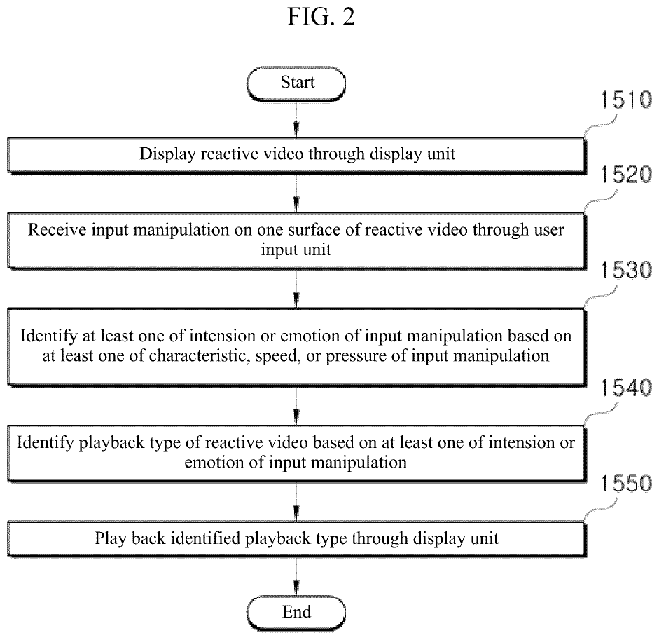

FIG. 2 is a flowchart for describing an operation of an electronic device playing back a reactive video based on an intention or an emotion of an input manipulation, according to the present disclosure. In FIG. 2, it may be understood that an operation of the electronic device 1400 is performed substantially by the processor 1410.

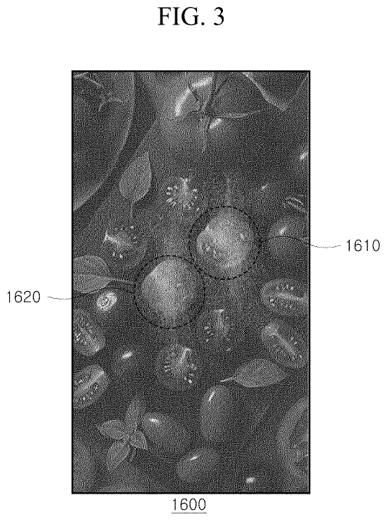

In operation 1510, the processor 1410 may display a reactive video through the display unit 1450. The reactive video may include at least one still screen (hereinafter referred to as “one screen”) for receiving the input manipulation. For example, one screen such as screen 1600 of FIG. 3 may be displayed in the display unit 1450.

In operation 1520, the processor 1410 may receive the input manipulation on the one screen of the reactive video through the user input unit 1430. The input manipulation may include, for example, a touch input, a swipe input, or a pinch in/out input. The input manipulation may be provided as an example and may include various inputs not disclosed in the specification. In operation 1520, the input manipulation may be understood as being associated with an object included in the one screen.

Referring to FIG. 3, the one screen 1600 of the reactive video may include at least one object (e.g., tomato) 1610 or 1620. The input manipulation of the user may be understood as being input to manipulate an object. The reactive video may include at least one playback type based on the input manipulation on the one screen 1600. For example, the input manipulation of the user is an operation of swiping the at least one object 1610 or 1620 from top to bottom, a playback type in which the tomato is vertically cut may be played back under control of the processor 1410. For example, the input manipulation of the user is an operation of swiping the at least one object 1610 or 1620 from left to right, a playback type in which the tomato is horizontally cut may be played back under control of the processor 1410.

Returning to FIG. 2, in operation 1530, the processor 1410 may identify at least one of the intention or the emotion of the input manipulation based on at least one of a characteristic, a speed, or a pressure of the input manipulation.

In an embodiment, the characteristic of the input manipulation may be understood as content linked to the input manipulation of the user. The processor 1410 may identify the intention of the user based on the characteristic of the input manipulation. For example, when the object moves to one point by the input manipulation (e.g., swiping) of the user in the reactive video, the processor 1410 may recognize the intention of the input manipulation as movement of the object.

In an embodiment, the processor 1410 may set an execution range of each input manipulation in advance. The execution range may be understood as an input manipulation range required for recognition of a relevant input manipulation. For example, for an input manipulation to be recognized as a swiping input, the input manipulation may be set to be received at a specified distance or more from the display unit 1450.

In an embodiment, to identify a playback type appropriate for the intention of the user, the processor 1410 may identify an execution level of an input manipulation having a relevant characteristic. When an execution level of input manipulation is a specified level or more, the processor 1410 may recognize the corresponding input manipulation as an input manipulation having a relevant intention. For example, the input manipulation (e.g., swiping) for moving an object to one point is insufficiently performed, the processor 1410 may identify whether the corresponding input manipulation is performed as much as a specified level (e.g., 80%) or more within the execution range. When the input manipulation is performed as much as the specified level or more, the processor 1410 may determine that an input manipulation having a relevant intention is received. In contrast, when the execution level of the input manipulation is smaller than or equal to the specified level (e.g., 80%), the processor 1410 may ignore the corresponding input manipulation, and thus, an unintended abnormal operation may be prevented.

In an embodiment, the specified level may be set in advance by the electronic device 1400. In another embodiment, the specified level may be determined statistically. For example, the processor 1410 may collect records of input manipulations applied to the object of the one screen during a preset time interval and may determine the specified level based on a statistical value of the collected input manipulation records.

In an embodiment, the processor 1410 may identify at least one of the intention and the intensity of the input manipulation based on the speed of the input manipulation.

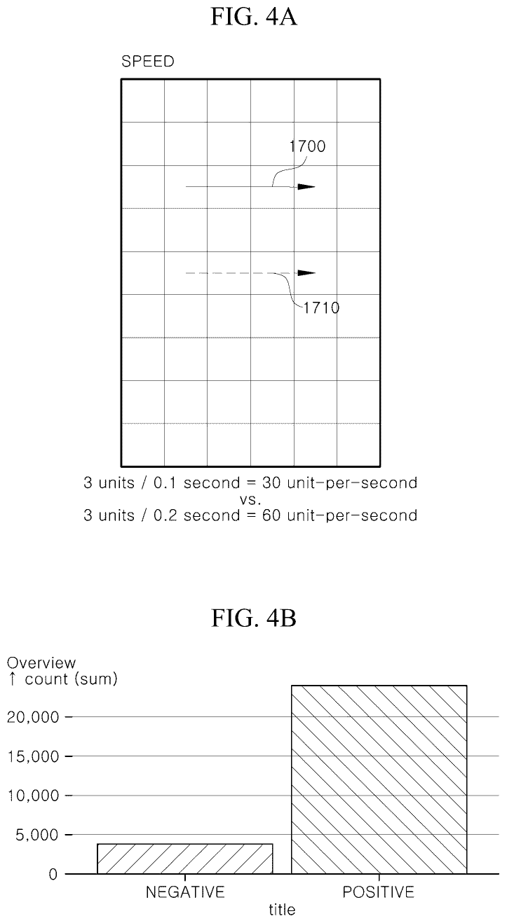

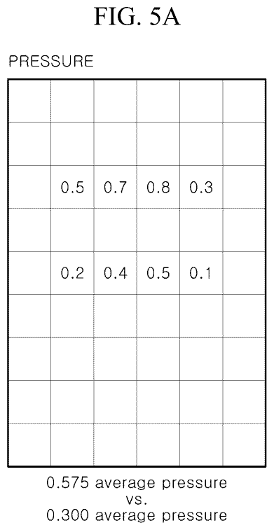

In an embodiment, the processor 1410 may obtain the speed of the input manipulation as illustrated in FIG. 4A. The processor 1410 may identify the intention of the manipulation based on the speed of the input manipulation. For example, the processor 1410 may identify that the intensity of an input manipulation corresponding to the case (1700) where the swiping on the object is made in a preset time (e.g., one second) is stronger than the intensity of an input manipulation corresponding to the case (1710) where the swiping is maintained during a time exceeding the preset time. The processor 1410 may play back different playback types based on intensities of the input manipulation.

In an embodiment, the processor 1410 may identify the emotion of the input manipulation based on the speed of the input manipulation. The emotion of the input manipulation may be expressed based on a result of digitizing a positive or negative degree as illustrated in FIG. 4B. For example, the processor 1410 may identify that the emotion of an input manipulation corresponding to the case where a touch input on the object is made plural times (e.g., two times) in a preset time (e.g., one second) is more negative than the emotion of an input manipulation corresponding to the case where the touch input is maintained during a time exceeding the preset time. The processor 1410 may play back different playback types based on emotions of the input manipulation.

In an embodiment, the processor 1410 may change a method of measuring the speed of the input manipulation, depending on the physical size and characteristic of the display unit 1450. An input manipulation speed measuring method of a smartphone may be different form an input manipulation speed measuring method of a kiosk. For example, when sizes and the numbers of pixels of the display units 1450 thereof are different, the processor 1410 may measure the speed of the input manipulation based on a pixel distance by which the input manipulation is moved. In detail, the processor 1410 may normalize a value measured based on the pixel distance in proportion to the size of a screen and may then identify the intention and/or the emotion of the corresponding input manipulation based on the normalized value.

In an embodiment, the processor 1410 may identify the intention and the emotion of the input manipulation based on the magnitude of a pressure.

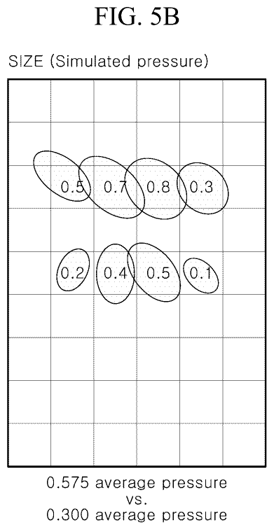

In an embodiment, the at least one sensor 1440 of the electronic device 1400 may include a pressure sensor. The electronic device 1400 may identify the magnitude of a pressure applied through the input manipulation, as illustrated in FIG. 5A, by using the pressure sensor. For example, the processor 1410 may identify that an input manipulation with a larger pressure is an input manipulation on the object, which has a greater intensity. For example, the processor 1410 may identify that an input manipulation with a larger pressure is an input manipulation on the object, which has a more negative emotion. The processor 1410 may play back different playback types based on intensities and emotions of the input manipulation.

In an embodiment, when the at least one sensor 1440 does not include the pressure sensor, the processor 1410 may identify the intention and the emotion of the input manipulation based on the area of an input manipulation point, as illustrated in FIG. 5B.

In an embodiment, the area of the input manipulation point may be measured through width and height information (w*h) of the input region. In another embodiment, the area of the input manipulation point may be measured through radius information of the input region.

In an embodiment, the processor 1410 may change a method of measuring the pressure of the input manipulation, depending on the characteristic of the display unit 1450. For example, the processor 1410 may measure the area of the input manipulation by obtaining the size of the input region in units of pixel and comparing the size of the input region with the physical size (dpi) of the display unit 1450. In this case, the processor 1410 may normalize the size of the input region measured in units of pixel in proportion to the size of a screen and may identify the intention and the emotion of the input manipulation based on the normalized value. Herein, a normal distribution table for calculating the normalized value may be a heuristic value. Alternatively, the normal distribution table may be a statistical value generated under the assumption that the collected input manipulation data are of a normal distribution.

In an embodiment, the processor 1410 may use the machine learning model 1425 to identify the intention and the emotion of the input manipulation. For example, the processor 1410 may train the machine learning model 1425 by using at least one of the characteristic, the speed, and the pressure obtained from the input manipulation and intention and emotion information of the input manipulation identified therefrom. The processor 1410 may input the input manipulation to the machine learning model 1425 completely trained and may obtain the intention and the emotion of the input manipulation as an output value.

Returning to FIG. 2, in operation 1540, the processor 1410 may identify the playback type of the reactive video based on at least one of the intention or the emotion of the input manipulation. In one embodiment, the one screen of the reactive video may include a balloon as an object. The processor 1410 may receive a touch input manipulation on the balloon. For example, when the intensity of the touch input is strong or the emotion is negative, the processor 1410 may identify a video, in which the balloon bursts, as the playback type. For another example, when the intensity of the touch input is weak or the emotion is positive, the processor 1410 may identify a video, in which the balloon is flattened, as the playback type.

In operation 1550, the processor 1410 may play back the identified playback type through the display unit 1450.

Meanwhile, the disclosed embodiments may be implemented in the form of a recording medium storing instructions executable by a computer. The instructions may be stored in the form of a program code, and the instructions, when executed by a processor, may generate a program module to perform the operations of the disclosed embodiments. The recording medium may be implemented with a computer-readable recording medium.

The computer-readable recording medium includes all types of recording media storing instructions capable of being interpreted by the computer. For example, there may be a read only memory (ROM), a random access memory (RAM), a magnetic tape, a magnetic disk, a flash memory, an optical data storage device, etc.

The disclosed embodiments are described with reference to the accompanying drawings as described above. One skilled in the art to which the present disclosure pertains will understand that the present disclosure may be carried out to be different in form from the disclosed embodiments without changing the technical idea or essential features of the present disclosure. The disclosed embodiments are provided as an example and should not be construed as limited.

1. An electronic device comprising:
a touchscreen configured to display a reactive video; and
a processor configured to control a playback operation of the reactive video,
wherein the processor is configured to:
receive an input manipulation on one screen of the reactive video through the touchscreen;
identify at least one of an intention and an emotion of the input manipulation based on at least one of a characteristic, a speed, and a pressure of the input manipulation;
identify a playback type of the reactive video based on at least one of the intention and the emotion of the input manipulation; and
play back the reactive video based on the identified playback type.

2. The electronic device of claim 1, wherein the reactive video is a multi-reactive video.

3. The electronic device of claim 2, wherein the processor is configured to:
identify the characteristic of the input manipulation based on an execution level of the input manipulation.

4. The electronic device of claim 3, wherein the processor is configured to:
record a plurality of input manipulations on the one screen;
determine a specified level based on a statistical value of the plurality of input manipulations; and
identify the characteristic of the input manipulation by comparing the execution level of the input manipulation with the specified level.

5. The electronic device of claim 4, wherein the processor is configured to:
normalize a pixel distance by which the input manipulation is moved, based on a size of the display unit; and
identify the speed of the input manipulation based on the normalized value.

6. The electronic device of claim 5, wherein the processor is configured to:
identify the pressure of the input manipulation based on an area of an input region to which the input manipulation is applied, and
wherein the area of the input region is measured based on width and height information of the input region or radius information of the input region.

7. The electronic device of claim 5, further comprising:
a pressure sensor,
wherein the processor is configured to:
identify a magnitude of the pressure of the input manipulation through the pressure sensor.

8. The electronic device of claim 7, further comprising:
a memory including a machine learning model,
wherein the processor is configured to:
train the machine learning model by using a plurality of input manipulations having at least one of a characteristic, a speed, and a pressure and at least one of pieces of intention and emotion information of the plurality of input manipulations; and
input the input manipulation to the machine learning model to obtain at least one of the intention and the emotion of the input manipulation as an output.

9. A method which plays back a reactive video based on an intension and an emotion of an input manipulation on the reactive video and is performed by an electronic device, the method comprising:
displaying the reactive video on a touchscreen of the electronic device;
when the input manipulation on one screen of the reactive video is received, identifying at least one of the intention and the emotion of the input manipulation based on at least one of a characteristic, a speed, and a pressure of the input manipulation;
identifying a playback type of the reactive video based on at least one of the intention and the emotion of the input manipulation; and
playing back the reactive video based on the identified playback type.

10. A computer-readable recording medium storing a program which is combined with a computer to execute the method of claim 9.
